(19) United States
(12) Patent Application Publication
(10) Pub. No.: US 2015/0302367 A1
(43) Pub. Date: Oct. 22, 2015

(54) SYSTEMS AND METHODS FOR FUNDING SOURCE SELECTION

(71) Applicant: Frederic Billou, Woodside, CA (US)

(72) Inventor: Frederic Billou, Woodside, CA (US)

(21) Appl. No.: 14/256,698

(22) Filed: Apr. 18, 2014

(51) Int. Cl. G06Q 20/10; G06Q 20/38

(52) U.S. Cl. CPC G06Q 20/10; G06Q 20/381

(57) ABSTRACT

A system and/or method may be provided to select a funding source to avoid or minimize currency conversion cost for the payer. In particular, a payer may have a plurality of funding sources available for making payments. The available funding sources may make payments in different currencies. In order to avoid currency conversion fees, one or more funding sources may be selected such that the currency of the funding sources matches the currency accepted by the payee. If the available funding sources do not have a currency that matches the currency accepted by the payee, one or more funding sources may be selected to minimize the currency conversion cost.

### BACKGROUND

1. Field of the Invention

The present invention generally relates to systems and methods for implementing funding source selection.

2. Related Art

In today's commerce, many payment transactions, such as retail purchases, fund transactions, and the like, are made electronically using a payment service provider. In particular, a customer may have various funding sources, such as different credit cards, bank accounts, debit cards, and the like, to choose from when making payments. The payee or the recipient of a transaction may require a currency different from that of the funding source. Depending on which funding source is used, the operator of the funding source, such as a credit card, may charge a currency conversion fee for currency conversion between a payer and a payee. Therefore, there is a need for a system or method that helps select a funding source to avoid or minimize currency conversion costs for the payer.

### BRIEF DESCRIPTION OF THE FIGURES

FIG. 1 is block diagram of a networked system suitable for implementing funding source selection according to an embodiment.

FIG. 2 is a flowchart showing a process for setting up funding sources according to one embodiment.

FIG. 3 is a flowchart showing a process for selecting funding sources according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system and/or method may be provided to select a funding source to avoid or minimize currency conversion cost for the payer. In particular, a payer may have a plurality of funding sources available for making payments. The available funding sources may make payments in different currencies. In order to avoid currency conversion fees, one or more funding sources may be selected such that the currency of the funding sources matches the currency accepted by the payee. If none of the available funding sources have a currency that matches the currency accepted by the payee, one or more funding sources may be selected to minimize the currency conversion cost.

In an embodiment, the payment is made at a brick-and-mortar merchant and the accepted currency of the merchant is determined based on the location of the merchant or the location of the payer. In another embodiment, the payment is made online and the currency accepted by the online merchant is determined based on the web address of the merchant or the currency symbol listed on the web site of the merchant. In yet another embodiment, the payment is made to an individual and the currency accepted by the individual is determined based on the address of the individual. In still another embodiment, the funding sources are used for withdrawing cash at an automated teller machine (ATM) and the currency accepted at the ATM is determined based on the location of the ATM.

In an embodiment, different currency exchange rates may be considered when comparing different funding sources. In particular, for the same currency conversion, different exchange rates offered at different funding sources may be compared to determine a favorable exchange rate for the user. Further, different sets of currency conversions may be compared to determine a favorable currency conversion for the user. For example, based on recent market movement, a conversion from US dollars to Euro may be more favorable for the user than a conversion from Japanese Yuan to Euro.

In an embodiment, notifications may be generated to inform a user regarding change in accepted currency. In particular, the location and movement of the user may be monitored or tracked. A notification may be generated and sent to the user to indicate that the local currency has changed based on the user's movement between different currency locations. For example, when the user moves across a country border, a notification may be generated to notify the user that a different currency should be used to make payments. Further, one or more funding sources may be suggested to avoid or minimize currency conversion costs for the new location.

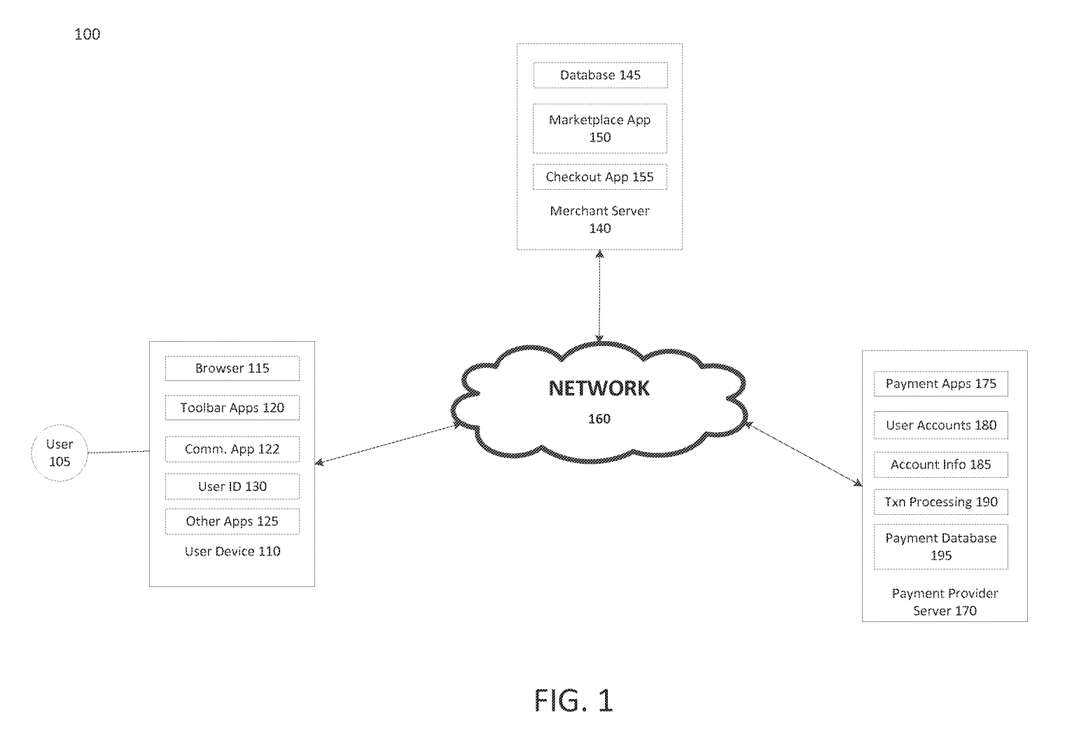

FIG. 1 is a block diagram of a networked system 100 configured to implement a process for notifications of incentives offered by funding sources in accordance with an embodiment of the invention. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a L1NUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 160. Payment provider server 170 may be maintained by a payment service provider, such as PayPal, Inc. of San Jose, Calif. A user 105, such as a consumer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, wearable device, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a smart wallet through the payment provider as discussed above.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

User device 110 may include applications for collecting location data, such as geo-location data via Global Positioning System (GPS), temperature data, altitude data, humidity data, data regarding device movement, ambient sound data, imaging data via a camera, and etc. Further, geo-fencing or wireless beacon technology may be used to define a location. User device 110 may detect signals from devices that implement geo-fencing or wireless beacon technology. These environmental data may be utilized to determine a location or environment in which user device 110 is located.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be a donation to charity. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 360 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display infomiation, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, user names, phone numbers, credit card information, bank information, or other financial information which may be used to facilitate online transactions by user 1.05. Account information may also include user purchase history and user ratings. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

In one embodiment, payment provider server 170 may receive information related to currencies of various funding sources of user 105's account. For example, each funding source may implement transactions in a preferred currency. When a transaction is made in a currency different from the preferred currency, currency conversion may be needed. Each funding source may charge a currency conversion fee for converting from one to another currency. Payment provider server 170 may include a funding source database storing information regarding the various currencies preferred by respective funding sources and currency conversion fees charged by the various funding sources. The funding source database may continuously be updated to store the most updated currency related information.

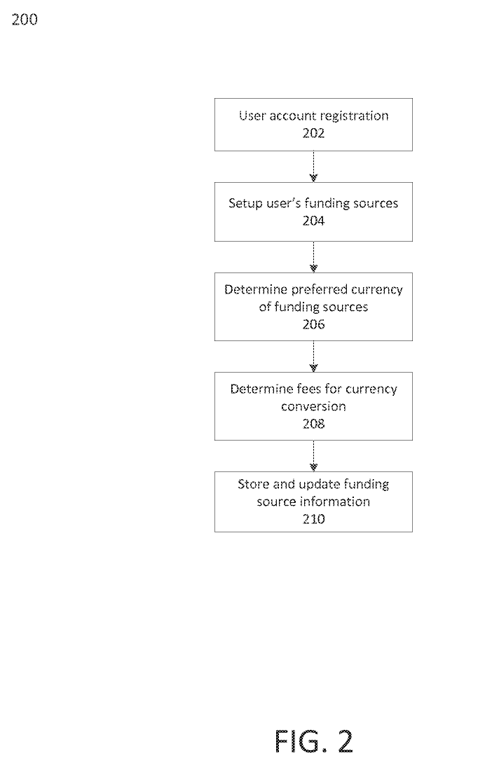

FIG. 2 is a flowchart showing a process 200 for setting up funding sources according to one embodiment. At step 202, payment provider server 170 may receive user 105's account registration. In particular, user 105 may set up a payment account at the payment service provider to make and receive payments. At step 204, user 105 may designate one or more funding sources, such as credit cards, debit cards, bank accounts, gift cards, and the like, that may be used to fund the payment account or to make payments.

At step 206, payment provider server 170 may determine preferred currency of the funding sources designated in user 105's account. The preferred currency of the funding source may be indicated by the transaction policy of the funding source. In an embodiment, the preferred currency of the funding source may be determined from past transactions conducted through the funding sources by the user 105 or other users.

If the funding source is a payment card, such as a credit or debit card, the identity of the issuing bank of the payment card may be determined based on the Bank Identification Number (BIN) of the credit card. The preferred currency of the payment card may then be determined based on the location of the issuing bank. If the funding source is a bank account, the identity of the bank may be determined from the bank routing number. As such, the location of the bank may be used to determine the preferred currency of the bank account. For example, a funding source may be a Visa card issued from a bank in Mexico. As such, the preferred currency may be pesos for that Visa card.

At step 208, payment provider server 170 may determine fees for currency conversion for each funding sources designated in user 105's account. The currency conversion fees may be indicated in the transaction policy or fee schedule of the funding sources or may be determined from past transactions conducted through the funding source by user 105 or other users. The currency conversion fee may be a percentage, e.g., 2.5%, of the transaction amount or a fixed amount for each transaction. For the same funding source, the currency conversion fee may be different for converting into different currencies.

Payment provider server 170 may maintain a general database of currencies preferred by various funding sources. The preferred currencies of various funding sources may be determined based on past transactions completed by user 105 or other users. The preferred currencies may be determined by locations of the funding sources or from transaction policy of the funding sources. Further, the general database also may include currency conversion fees charged by the various funding sources. The currency conversion fee may be a percentage of the transaction amount or a fixed amount for each transaction. The currency conversion fees charged by various funding sources may be determined based on past transactions conducted by user 105 or other users or from transaction policies of the various funding sources. At step 210, the general currency database of funding sources may be updated continuously to reflect the most recent changes.

By using the above process 200, various preferred currencies at various funding sources may be determined. Further, various currency conversion fees charged by various funding sources may be determined. The database storing the preferred currencies and currency conversion fee schedules for various funding sources may continuously be updated to reflect the most recent updates.

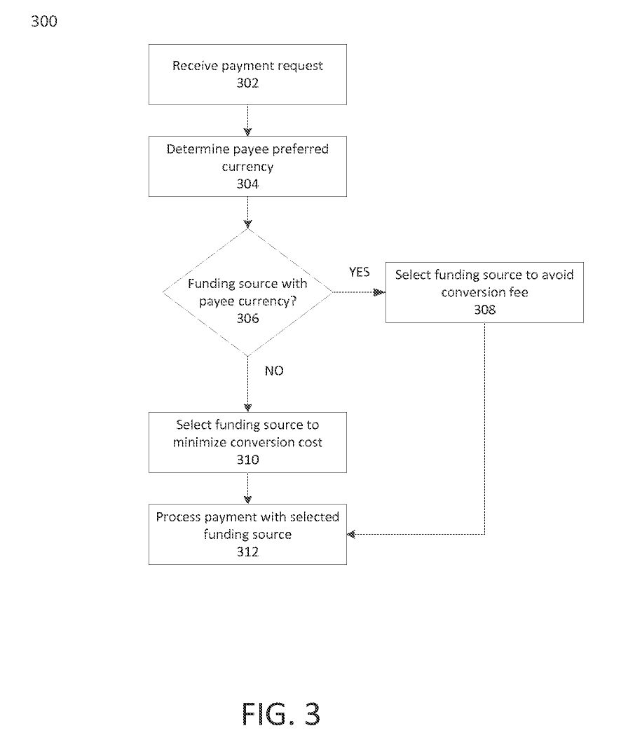

FIG. 3 is a flowchart showing a process for selecting funding sources according to one embodiment. At step 302, payment provider server 170 may receive a payment request from user 105. For example, user 105 may attempt to make a payment using user device 110. A payment request may be sent from user device 110 to payment provider server 170. The payment request may include the payment account to be used for payment, identity of the payee, the amount of payment, and the like.

At step 304, payment provider server 170 may determine the preferred currency of the payee. The preferred currency of the payee may be determined by looking up the preferred currencies of merchants or banks from database as noted in 210 above. In an embodiment, the preferred currency of the payee may be determined based on the location of the payee. For example, if user 105 is making a purchase at a point of sale of a brick-and-mortar store, the location of the user 105 may be used to determine the preferred currency of the store. User device 110 may include devices configured to detect the location of user device 110 via Global Positional System (GPS) or positioning beacons, such as Win or Bluetooth beacons. The location of user device 110 may be sent to payment provider server 170 and be used to determine the preferred currency at user 105's location.

If user 105 is making a purchase at an online merchant, the merchant's preferred currency may be determined based on the web address of the merchant. For example, a web address including “.uk” may indicate that the online merchant is in United Kingdom and may prefer the currency in British pounds (£). In another example, the web site of the online merchant may list prices or fees in the preferred currency, such as Japanese Yuen (¥). Thus, payment provider server may determine the preferred currency of the online merchant based on the listed prices on the merchant's website.

In an embodiment, user 105 may attempt to withdraw money from an ATM. The preferred currency of the ATM may be determined based on the location of the ATM, as detected at user device 110. In still another embodiment, the payee may be an individual. The preferred currency of an individual payee may be determined based on the address of the individual payee, which may be referenced from user 105's contact list or from user 105's social network. In some embodiments, user 105 may be inquired regarding the currency the payment is to be made. Thus, user 105 may designate the currency that the payment should be made.

At step 306, payment provider server 170 may determine whether user 105's payment account has a funding source that implements transactions in the preferred currency of the payee. If a funding source is available for making payments in the preferred currency of the payee, the funding source may be selected to make payments to the payee at step 308. As such, currency conversion is not needed to make payments from the selected funding source to the payee.

In an embodiment, the selected funding source may be notified to user 105 first. For example, a notification may be generated “The payee accepts currency XX, use credit card XX to avoid current conversion fees. Press “OK” to use credit card XX for the transaction or Press “No” to use the default payment method.” User 105 may press the “OK” button to use credit card XX to avoid currency conversion fees. At step 312, payment provider server 170 may process the requested payment using the selected funding source. For example, payment provider server 170 may debit the payment amount user 105's account at the selected funding source and credit the payment amount to the payee's account.

If user 105's payment account does not have a funding source that implements transactions in the preferred currency of the payee, payment provider server 170 may select a funding source or funding sources that minimize currency conversion cost at step 310. For example, payment provider server 170 may compare the currency conversion fees charged by the various funding sources designated in user 105's payment account. A funding source with the lowest currency conversion fee may be selected to make the payment. For some funding sources, the currency conversion fee may be a percentage of the transaction amount. As such, the payment provider server 170 may calculate the currency conversion fees based on the transaction amount. For other funding sources, the currency conversion fee may be a fixed amount. The payment provider server 170 may calculate and compare the conversion fees among the funding sources based on their respective fee schedules.

In an embodiment, the currency conversion cost comparison may include comparison among different currency exchange rates. In particular, for the same currency conversion, different funding sources may offer different currency exchange rates. A funding source with a more favorable conversion rate for user 105 may be selected. For example, the payee accepts payments in Euro ( [symbol] ), and user 105 may have a credit card and a bank account that both convert U.S. dollars ($) into Euros. If the bank account offers a more favorable currency exchange rate for user 105, e.g., more euros for each dollar, payment provider server 170 may select the bank account and suggest the bank account to user 105. Payment provider server 170 may connect with currency exchange market servers or the bank/funding source servers to obtain the most recent exchange rates offered at the various funding sources. As such, currency exchange rates may be considered in the overall cost of currency conversion.

In an embodiment, the payment provider server 170 may compare different currency conversions to select a more favorable conversion for user 105. For example, the payee accepts payments in Euro, and user 105 may have a credit card that converts from Japanese Yuan to Euro and a bank account that converts from U.S. dollars to Euro. The payment provider server 170 may check and compare the latest exchange rates and history between Yuan and Euro and between Dollars and Euro. If the exchange rate between Yuan and Euro is more favorable because Yuan recently appreciated relative to Euro while Dollars recently depreciated relative to Euro, the payment provider server 170 may select that credit card that converts Japanese Yuan to Euro for the payment to provide user 105 with a more favorable conversion rate.

Besides the various conversion fees and exchange rates, other factors, such as reward points, ATM processing fees, other processing fees, or the like, may also be considered when selecting a favorable funding source for user 105. In an embodiment, a comparison table listing various fees and factors for each funding source may be presented to user 105 to allow user to make informed decision regarding which funding source to select for the payment. After a funding source is selected and confirmed, the payment may be processed using the selected funding source at step 312.

By using the above process 300, the overall cost related to currency conversion for different funding sources may be compared and a favorable funding source may be selected to avoid or minimize currency conversion cost related to payments. In particular, currency conversion fees, currency conversion rates, and other factors may be considered for selecting a favorable funding source. Thus, user 105 may make informed decision when selecting a funding source for making payments in different currencies.

In the above processes, the steps are executed at payment provider server 170. In one embodiment, the steps may be executed at user device 110 or merchant server 140. In still another embodiment, the steps may be executed among payment provider server 170, user device 110, and merchant server 130 in coordination with each other.

The following are exemplary scenarios in which the above processes may be implemented.

### EXAMPLE 1

A user of a payment account at a payment service provider designates various credit cards, bank accounts, and other funding sources to make payments. These funding sources make payments in different currencies. In particular, a bank account implements transactions in U.S. dollars, a credit card implements transactions in Canadian dollars, and a debit card implements transactions in Euros. The user installs a payment application from the payment service provider at the user's mobile device to facilitate payments. The user typically uses the payment application on the mobile device to make payments electronically at various merchants. In particular, the user allows the payment application to select and/or suggest funding sources that minimize currency conversion costs.

The user is traveling in Europe and is using the payment account to make payments at various countries in Europe. When visiting France, the user makes payments in hotels and other stores. The payment service provider detects via the mobile device that the user is in France by the mobile device's GPS location. As such, the payment service provider suggests that the user uses the debit card to make payments in France because the debit card makes payments in Euro which is accepted in France. Thus, the user may avoid currency conversion fees when making payments in France.

When the user is visiting England, the payment service provider determines that the user does not have a funding source that makes payments in British pound. As such, the payment service provider compares the currency conversion costs among the different funding sources to determine a funding source that minimizes the cost of currency conversion. In particular, based on the transaction fee schedule, each of the credit card, the bank account, and the debit card each charges the same 2.5% of the transaction amount as the fee for currency conversion. Nevertheless, using the U.S. dollars as a base of comparison (because the user is from the U.S.), the exchange rate between Euro to British pound is more favorable to the user, because the British pound recently depreciated significantly against the Euro. Therefore, the payment service provider suggests that the user uses the debit card to make payments in England to minimize cost related to currency conversion.

Accordingly, the payment service provider provides comprehensive currency conversion cost comparison among different funding sources of the user. The user is able to make informed decisions regarding which funding source to use when making payments to different payees at different locations.

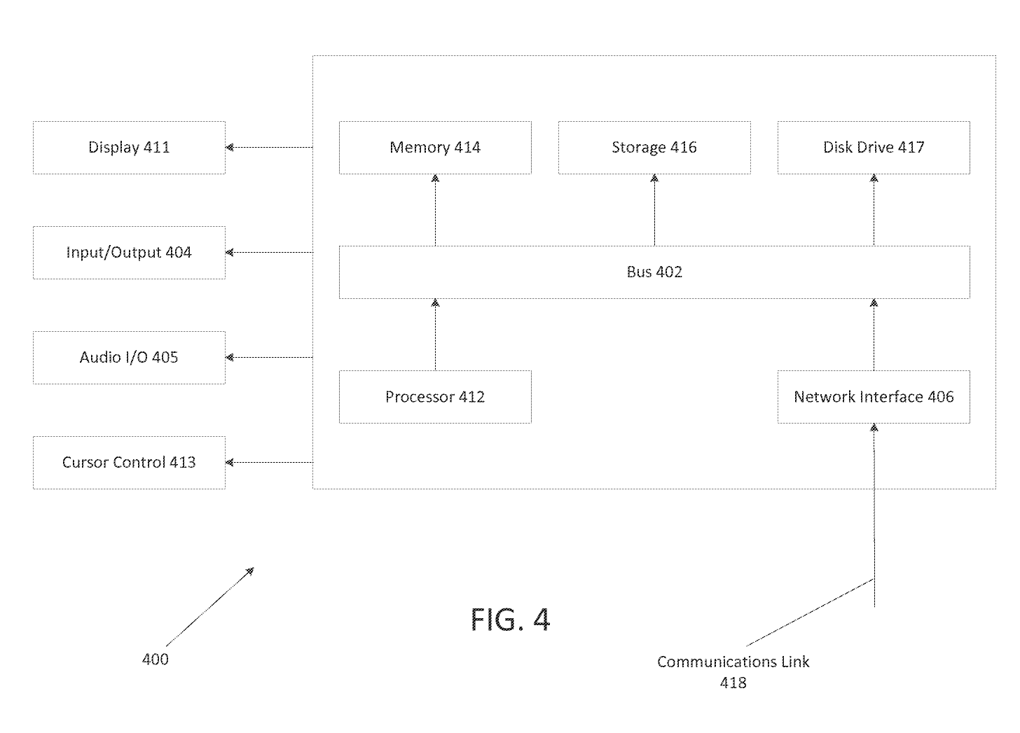

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, wearable device, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing a payment account of a user designating a plurality of funding sources for making payments; and
one or more processors in communication with the memory and adapted to:
determine a preferred currency of a payee;
perform a currency conversion cost comparison among the plurality of funding sources; and
select a particular funding source from the plurality of funding sources for making a payment to the payee based on the currency conversion cost comparison.

2. The system of claim 1, wherein the one or more processors are further adapted to determine a preferred currency of a funding source based on a Bank Identification Number (BIN) of a credit card associated with the funding source.

3. The system of claim 1, wherein the one or more processors are further adapted to determine a preferred currency of a funding source based on a bank routing number of a bank account associated with the funding source.

4. The system of claim 1, wherein the payee is a brick-and-mortar merchant store and the preferred currency of the payee is determined based on a location of the user.

5. The system of claim 1, wherein the payee is an individual and the preferred currency of the payee is determined based on an address of the individual referenced from the user's contact list or social network account.

6. The system of claim 1, wherein the payee is an online merchant and the preferred currency of the payee is determined based on a web address of the online merchant.

7. The system of claim 1, wherein the payment is made at an Automatic Teller Machine (ATM) and the preferred currency of the payee is determined based on a location of the ATM.

8. A method comprising:
receiving, by a hardware processor of a payment service provider, a payment request from a user of a payment account;
determining, by the hardware processor, a preferred currency of a payee of the payment request;
performing, by the hardware processor, a currency conversion cost comparison among a plurality of funding sources designated at the payment account of the user; and
selecting, by the hardware processor, a particular funding source from the plurality of funding sources for making a payment to the payee based on the currency conversion cost comparison.

9. The method of claim 8, wherein the particular funding source implements the same currency as the preferred currency of the payee.

10. The method of claim 8,
wherein the particular funding source implements a different currency from the preferred currency of the payee, and
wherein the particular funding source is selected to minimize currency conversion cost for the user.

11. The method of claim 8, wherein the currency conversion cost comparison comprises comparing currency conversion fees among the plurality of funding sources.

12. The method of claim 11, wherein the currency conversion fees are calculated based on a percentage of an amount of the payment.

13. The method of claim 8, wherein the currency conversion cost comparison comprises:
retrieving currency exchange rates currently offered at the plurality of funding sources; and
comparing the currency exchange rates offered at the plurality of funding sources.

14. The method of claim 8, wherein the currency conversion cost comparison comprises comparing currency exchange rates among different sets of currencies.

15. The method of claim 14, wherein recent market history of the currency exchange rates among the different sets of currencies are compared.

16. The method of claim 14, wherein the currency exchange rates among the different sets of currencies are compared with reference to a preferred currency of the user to determine a favorable set of currency exchange rate for the user.

17. A non-transitory computer-readable medium comprising instructions which, in response to execution by a computer system, cause the computer system to perform a method comprising:
receiving a payment request from a user of a payment account;
determining a preferred currency of a payee of the payment request;
performing a currency conversion cost comparison among a plurality of funding sources designated at the payment account of the user; and
selecting a particular funding source from the plurality of funding sources for making a payment to the payee based on the currency conversion cost comparison.

18. The non-transitory computer-readable medium of claim 17, wherein the particular funding source has a preferred currency matching the preferred currency of the payee.

19. The non-transitory computer-readable medium of claim 17, wherein the method further comprises:
monitoring a movement of the user; and
notifying the user of a change in preferred currency when the user moves from one currency zone to a new currency zone.

20. The non-transitory computer-readable medium of claim 19, wherein the method further comprises automatically select a funding source from the plurality of funding sources for the new currency zone to minimize currency conversion cost.
